(19) United States
(12) Patent Application Publication
(10) Pub. No.: US 2014/0187338 A1
(43) Pub. Date: Jul. 3, 2014

(54) Flexible Torque-Transferring Apparatus

(71) Applicant: Jie-Long CHEN, Taichung City (TW)

(72) Inventor: Jie-Long CHEN, Taichung City (TW)

(21) Appl. No.: 13/730,976

(22) Filed: Dec. 29, 2012

(51) Int. Cl. F16D 3/18

(52) U.S. Cl. CPC F16D 3/185
USPC 464/158

(57) ABSTRACT

A flexible torque-transferring apparatus includes a first end element, a second end element and a flexible connector for interconnecting the first and second end elements. The flexible connector includes a plurality of joints, each including a ball and a socket. The ball includes an end facet, a plurality of arched facets extending from the end facet, and a plurality of edges, each extending between two adjacent ones of the arched facets. The socket includes a cavity defined therein and a plurality of curved facets formed in the cavity. Each of the curved facets includes two ridges in contact with two portions of a corresponding one of the arched facets when the ball is placed in the socket.

### BACKGROUND OF INVENTION

1. Field of Invention

The present invention relates to a torque-transferring apparatus and, more particularly, to a flexible torque-transferring apparatus.

2. Related Prior Art

As disclosed in Taiwanese Patent Publication Nos. M357344 and M370471 and US Patent Application Publication No. 20110303053, a conventional flexible torque-transferring apparatus includes at least one joint consisting of a ball and a socket. The ball includes is formed with six arched while the socket includes six planar facets formed on the inside. The ball is placed in the socket so that the axis of the former can be pivoted relative to that of the latter. One of the arched facets of the ball is in contact with a corresponding one of the planar facets of the socket. Thus, torque can be transferred via the joint while the angle of the joint can be changed.

As disclosed in Patent Application Nos. GB217368, U.S. Pat. No. 4,730,960 and U.S. Pat. No. 6,952,986, a conventional flexible torque-transferring apparatus may include a flexible sheath around at least one joint. The flexible sheath protects but does not interfere with the joint.

In these conventional flexible torque-transferring apparatuses, the ball is inevitably rotatable in the socket since only one of the arched facets of the former is in contact with the corresponding one of the planar facets of the latter in operation. Hence, the ball is provided with a spring-biased detent for contact with another planar facet of the socket to limit the rotation of the ball in the socket.

The present invention is therefore intended to obviate or at least alleviate the problems encountered in prior art.

### SUMMARY OF INVENTION

It is the primary objective of the present invention to provide a reliable flexible torque-transferring apparatus.

To achieve the foregoing objective, the flexible torque-transferring apparatus includes a first end element, a second end element and a flexible connector for interconnecting the first and second end elements. The flexible connector includes a plurality of joints, each including a ball and a socket. The ball includes an end facet, a plurality of arched facets extending from the end facet, and a plurality of edges, each extending between two adjacent ones of the arched facets. The socket includes a cavity defined therein and a plurality of curved facets formed in the cavity. Each of the curved facets includes two ridges in contact with two portions of a corresponding one of the arched facets when the ball is placed in the socket.

In another aspect, the first end element includes an insert extending from a ball. The ball of the first end element is placed in the socket of one of the joints. The insert is inserted in a cavity defined in a portion of a wrench.

In another aspect, the second end element includes a receptacle formed together with a socket. The socket of the second end element receives the ball of one of the joints. The receptacle receives a nut or a head of a screw.

Other objectives, advantages and features of the present invention will be apparent from the following description referring to the attached drawings.

### BRIEF DESCRIPTION OF DRAWINGS

The present invention will be described via detailed illustration of five embodiments referring to the drawings wherein:

FIG. 1 is a cross-sectional view of a flexible torque-transferring apparatus according to the first embodiment of the present invention;

FIG. 2 is a perspective view of two links of the flexible torque-transferring apparatus shown in FIG. 1;

FIG. 3 is a cross-sectional view of the links shown in FIG. 2;

FIG. 4 is a cross-sectional view of the links taken along a line A-A shown in FIG. 3;

FIG. 5 is a cross-sectional view of two links of a flexible torque-transferring apparatus according to the second embodiment of the present invention;

FIG. 6 is a cross-sectional view of a flexible torque-transferring apparatus according to the third embodiment of the present invention;

FIG. 7 is a cross-sectional view of two links of a flexible torque-transferring apparatus according to the fourth embodiment of the present invention; and

FIG. 8 is a cross-sectional view of two links of a flexible torque-transferring apparatus according to the fifth embodiment of the present invention.

### DETAILED DESCRIPTION OF EMBODIMENTS

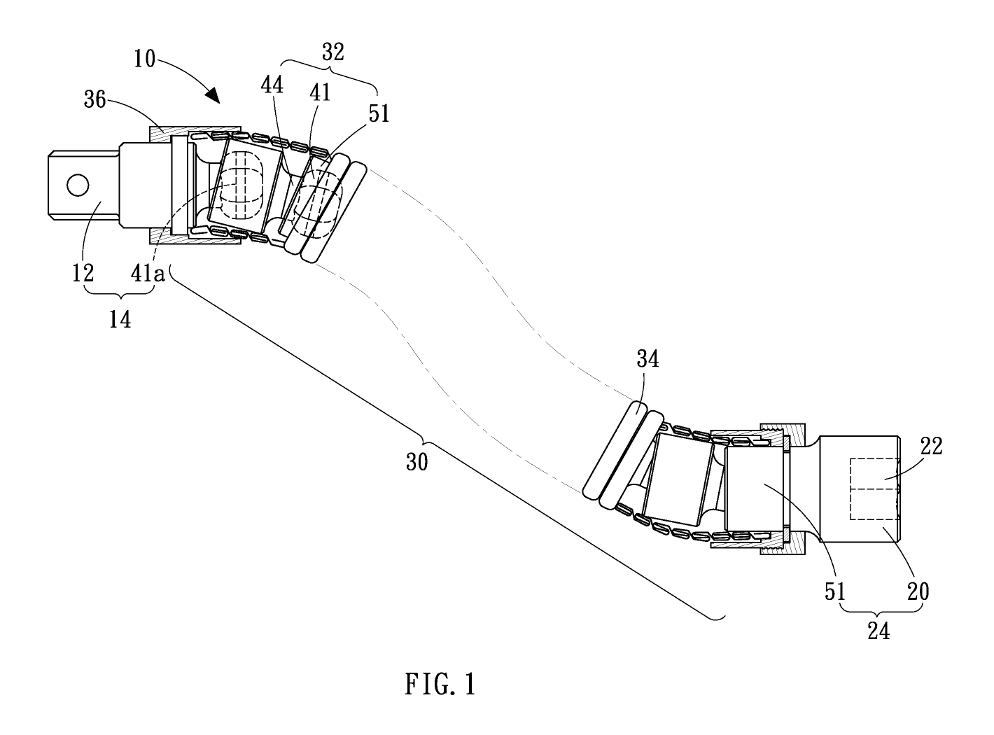

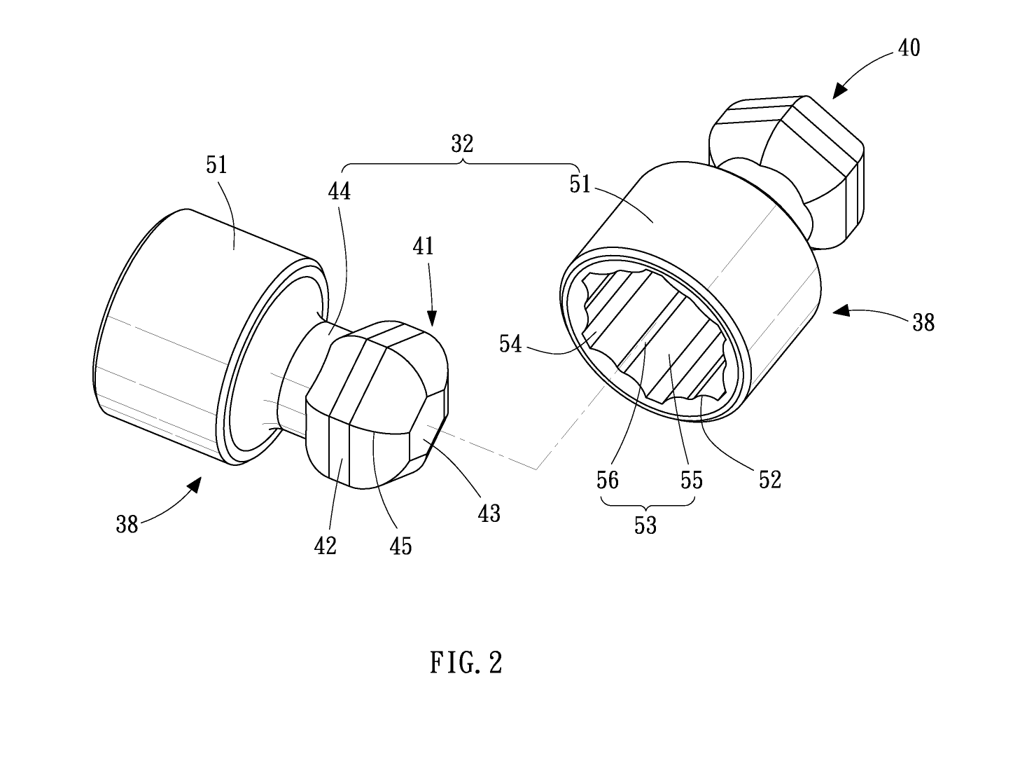

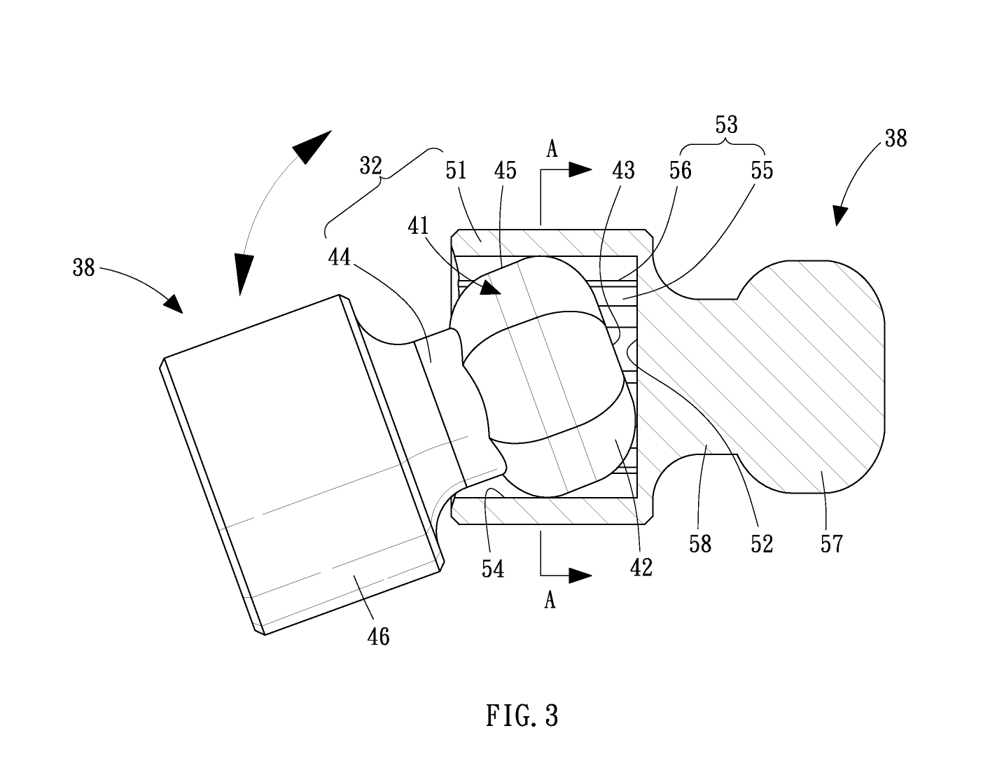

Referring to FIGS. 1 through 4, shown is a flexible torque-transferring apparatus 10 according to a first embodiment of the present invention. The flexible torque-transferring apparatus 10 includes an insert 12 formed at an end, a receptacle 20 formed at another end, and a flexible connector 30 for connecting the insert 12 to the receptacle 20. The insert 12 is made with a square configuration so that it can be inserted in a square cavity defined in a socket or extensive rod of a socket wrench for example. The receptacle 20 includes a hexagonal cavity 22 for receiving a nut or a head of a screw.

The flexible connector 30 includes a flexible sheath 34 for protecting, without interfering with, a plurality of links 38 pivotally connected to each other. Each of the links 38 includes a ball 41, a socket 51 and a neck 44 extending from the ball 41 to the socket 51. The ball 41 of each link 38 is pivotally placed in the socket 51 of adjacent link 38 so that they together form a joint 32.

The ball 41, the neck 44 and the socket 51 are preferably made different parts of a single element. The ball 41, the neck 44 and the socket 51 may however be elements that are formed separately and then joined together by proper means.

The ball 41 includes a hexagonal end facet 43, six arched facets 42 and six edges 45. Each of the arched facets 42 extends from the hexagonal end facet 43 to the neck 44. Each of the edges 45 extends between two adjacent ones of the arched facets 42.

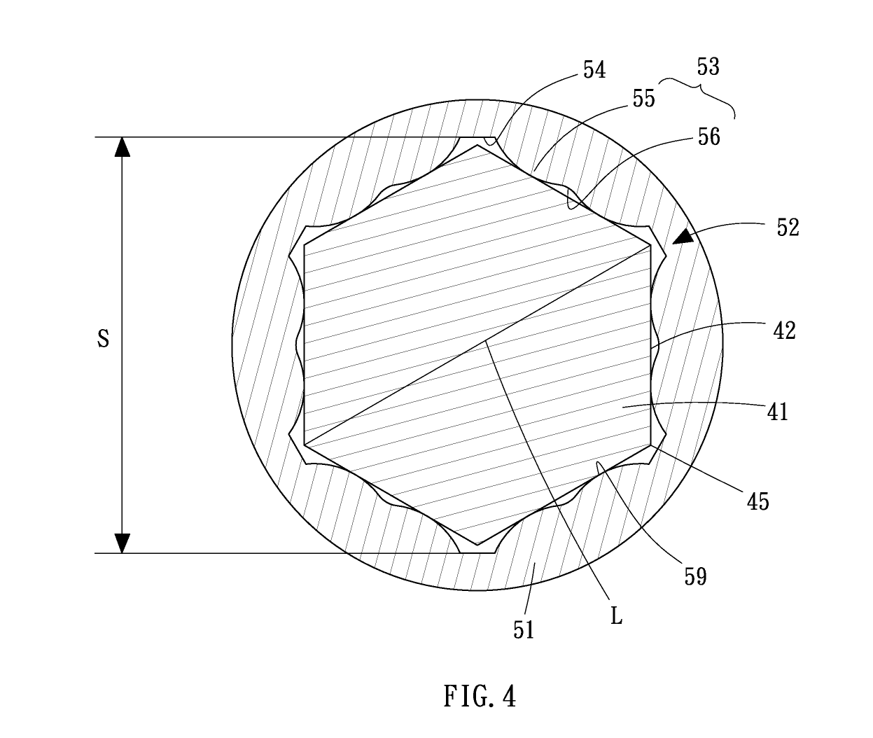

The socket 51 includes a cavity 52 defined therein. An internal side of the socket 51 (or “the wall of the cavity 52”) includes six curved facets 53 and six grooves 54, each extending between two adjacent ones of the curved facets 53. As shown in FIG. 4, each of the curved facets 53 includes two ridges 55 and a valley 56 extending between the ridges 55. Each of the ridges 55 is formed with a peak 59.

The insert 12 is formed together with or connected by proper means to a ball 41 via a neck 44. The insert 12, the corresponding ball 41 and the corresponding neck 44 together form an end element 14.

The receptacle 20 is formed together with or connected by proper means to a socket 51. The sockets 20 and the corresponding socket 51 together form another end element 24.

The flexible sheath 34 may be a metal hose. An end of the flexible sheath 34 is fit on the end element 14 by a collar 36. Another end of the flexible sheath 34 is fit on the end element 24 by another collar 36. With the flexible sheath 34, the links 38 and the elements 12 and 24 are kept connected to one another.

Referring to FIG. 4, a diagonal length L of the ball 41 is shorter than the distance S between two opposite ones of the grooves 54. The distance between two opposite ones of the arched facets 43 is shorter than the distance between the peaks 59 of two opposite ones of the curved facets 53. Hence, in each of the joints 32, the ball 41 can deeply be inserted in the socket 51.

In operation, torque is transferred to the end element 14 from the end element 24 via the flexible connector 30, or vice versa, while the flexible connector 30 can be curved. Each of the arched facets 42 can be in contact with the peaks 59 of a corresponding one of the curved facets 53. Hence, the rotation of the ball 41 about its axis in the socket 51 is limited. By the neck 44, the pivoting of the axis of the ball 41 relative to the axis of the socket 51 is limited. The edges 45 are placed in the grooves 54 so that the edges 45 are kept from causing any damage to the socket 51.

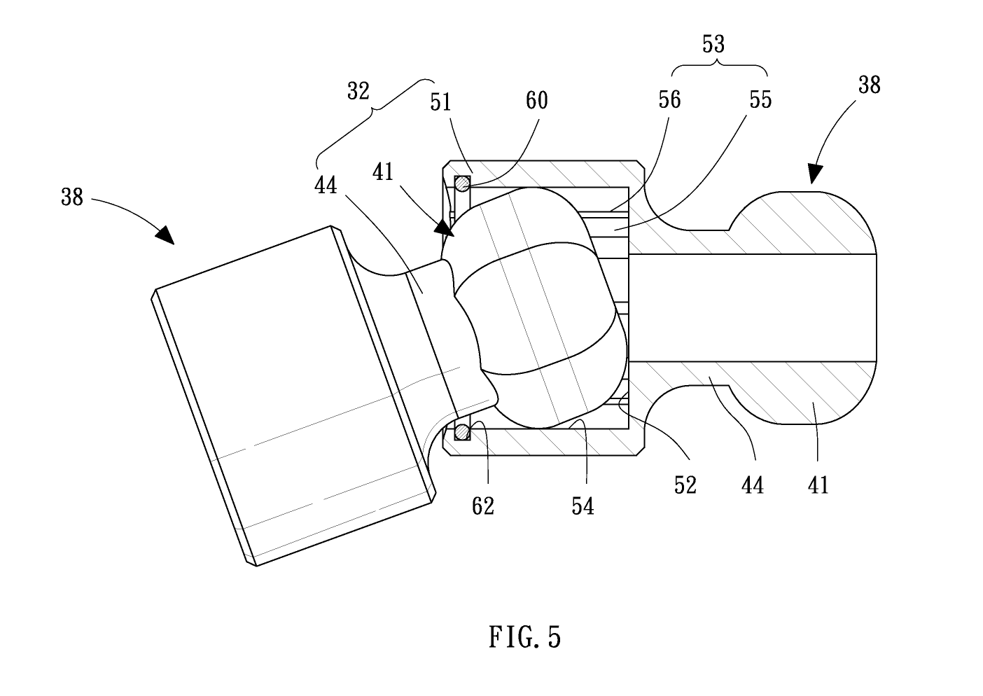

Referring to FIG. 5, shown is a joint 32 of a flexible torque-transferring apparatus according to a second embodiment of the present invention. The second embodiment is like the first embodiment except two things. At first, the ball 41 of each of the links 38 is kept in the socket 51 of an adjacent one of the links 38 by a ring 60 placed in an annular groove 62 defined in the internal side of the socket 51. Secondly, the ball 41 and the neck 44 are made hollow to reduce the amount of material used in each of the links 38 to reduce the weight and cost.

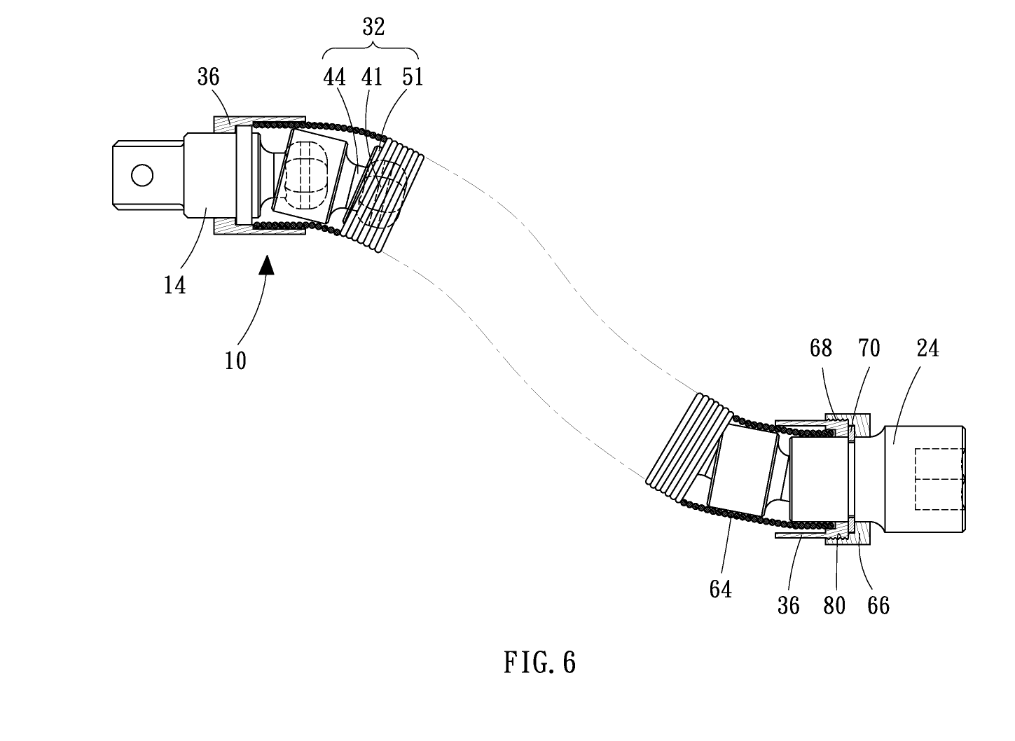

Referring to FIG. 6, shown is a flexible torque-transferring apparatus according to a third embodiment of the present invention. The third embodiment is like the first embodiment except two things. At first, a helical spring 64 is used instead of the flexible sheath 34. Secondly, there are provided a nut 66 and a washer 70 additionally. The nut 66 includes a thread 80 engaged with a thread 68 formed on an internal side of the collar 36 that kept an end of the helical spring 64 on the socket 51 of the end element 24. The washer 70 is placed between the nut 66 and the collar 36. The links 38 are kept in the helical spring 64 as the end element 24 is firmly connected to the helical spring 64.

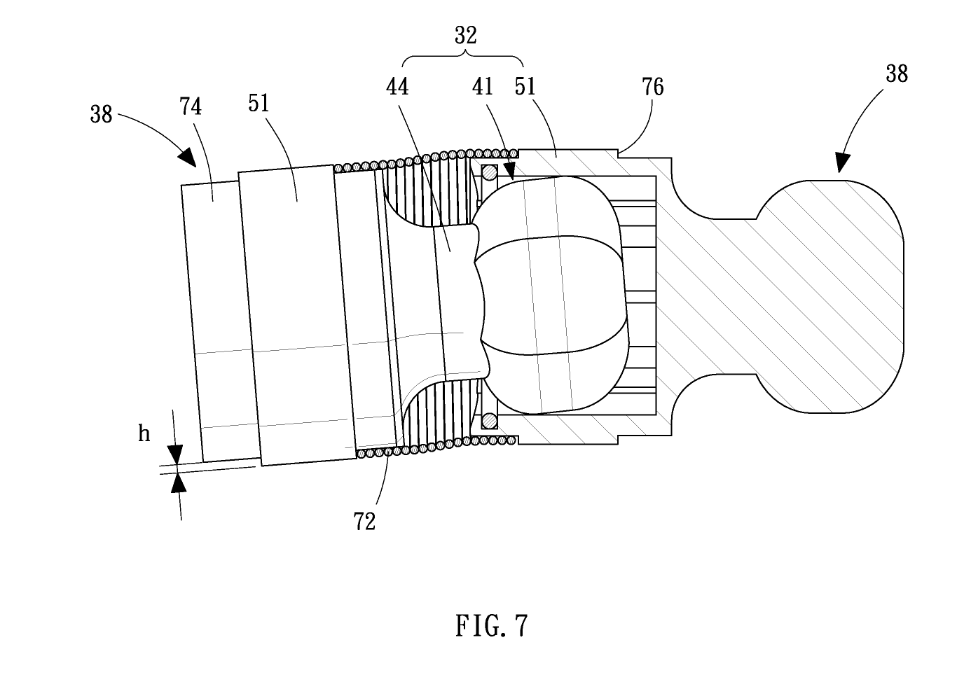

Referring to FIG. 7, shown is a joint 32 of a flexible torque-transferring apparatus according to a fourth embodiment of the present invention. The fourth embodiment is like the second embodiment except including a helical spring 72 in each of the joints 32 instead of the flexible sheath 34 for all of the joints 32. Secondly, the socket 51 of each of the links 38 includes two reduced sections 74 and 76. The helical spring 72 includes a section placed on the first reduced section 74 of the socket 51 of one of the links 38 and another section placed on the second reduced section 76 of the socket 51 of the other link 38. Preferably, the helical spring 72 is flush with the sockets 51.

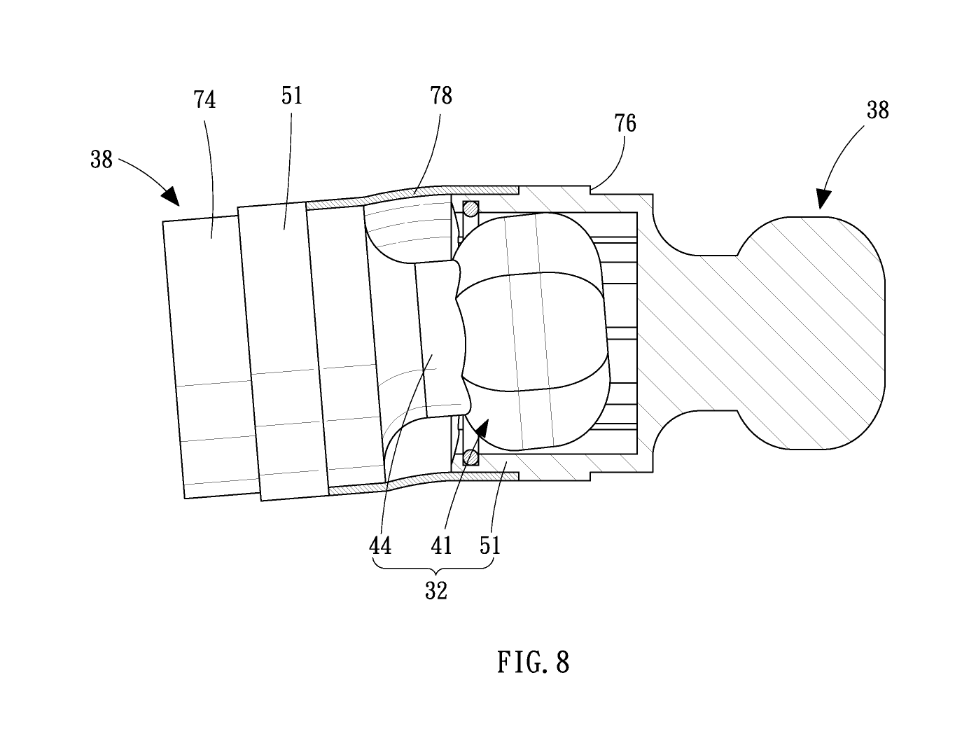

Referring to FIG. 8, shown is a joint 32 of a flexible torque-transferring apparatus according to a fifth embodiment of the present invention. The fifth embodiment is like the fourth embodiment except that each of the joints 32 includes a flexible sheath 78 instead of the helical spring 72. Preferably, the flexible sheath 78 is flush with the sockets 51.

The present invention has been described through the detailed illustration of the embodiments. Those skilled in the art can derive variations from the embodiments without departing from the scope of the present invention. Hence, the embodiments shall not limit the scope of the present invention defined in the claims.

1. A flexible torque-transferring apparatus including a first end element, a second end element and a flexible connector for connecting the first end element to the second end element, wherein the flexible connector including a plurality of joints, each including:
a ball including an end facet, a plurality of arched facets extending from the end facet, and a plurality of edges, each extending between two adjacent ones of the arched facets; and
a socket including a cavity defined therein and a plurality of curved facets formed in the cavity, wherein each of the curved facets includes two ridges in contact with two portions of a corresponding one of the arched facets when the ball is placed in the socket.

2. The flexible torque-transferring apparatus according to claim 1, wherein the socket includes a groove between any two adjacent ones of the curved facets.

3. The flexible torque-transferring apparatus according to claim 1, wherein each of the curved facets includes a valley between the ridges.

4. The flexible torque-transferring apparatus according to claim 1, wherein the first end element includes:
a ball including an end facet, a plurality of arched facets extending from the end facet, and a plurality of edges, each extending between two adjacent ones of the arched facets, wherein the ball of the first end element is placed in the socket of one of the joints; and
an insert extending from the ball.

5. The flexible torque-transferring apparatus according to claim 1, wherein the second end element includes:
a socket including a cavity defined therein and a plurality of curved facets formed in the cavity, wherein the socket of the second end element receives the ball of one of the joints; and
a receptacle extending from the socket.

6. The flexible torque-transferring apparatus according to claim 1, wherein each of the joints further includes a ring, wherein the socket includes an annular groove for receiving the ring to keep the ball in the socket.

7. The flexible torque-transferring apparatus according to claim 1, wherein the flexible connector includes a flexible sheath for protecting the joints.

8. The flexible torque-transferring apparatus according to claim 7, wherein the flexible sheath is a metal hose.

9. The flexible torque-transferring apparatus according to claim 7, wherein the flexible sheath includes a helical spring.

10. The flexible torque-transferring apparatus according to claim 1, wherein each of the joints further includes a flexible sheath fit on the socket at an end and fit on the socket of an adjacent one of the joints on at another end.

11. The flexible torque-transferring apparatus according to claim 10, wherein the flexible sheath is a metal hose.

12. The flexible torque-transferring apparatus according to claim 10, wherein the flexible sheath includes a helical spring.

13. The flexible torque-transferring apparatus according to claim 10, wherein the socket further includes a first reduced section and a second reduced section, wherein the flexible sheath is fit on the first reduced section of the socket of each of the joints at an end and fit on the second reduced section of the socket of an adjacent one of the joints on at another end.

14. The flexible torque-transferring apparatus according to claim 13, wherein the flexible sheath is flush with the sockets of the two adjacent ones of the joints.

15. The flexible torque-transferring apparatus according to claim 1, wherein the ball of each of the joints is secured to the socket of an adjacent one of the joints so that they together form a link.

16. The flexible torque-transferring apparatus according to claim 15, wherein the ball is formed together with the socket in each of the links.

17. The flexible torque-transferring apparatus according to claim 16, wherein each of the links further includes a neck extending from the ball to the socket.
